(19) United States
(12) Patent Application Publication
(10) Pub. No.: US 2022/0051357 A1
(43) Pub. Date: Feb. 17, 2022

(54) SYSTEM AND METHOD FOR ATTORNEY-CLIENT PRIVILEGED DIGITAL EVIDENCE CAPTURE, ANALYSIS AND COLLABORATION

(71) Applicant: Rocket Lawyer Incorporated, San Francisco, CA (US)

(72) Inventors: Charles L. Moore, San Francisco, CA (US); Mark Edwards, London (GB)

(73) Assignee: Rocket Lawyer Incorporated, San Francisco, CA (US)

(21) Appl. No.: 17/393,259

(22) Filed: Aug. 3, 2021

Related U.S. Application Data
(60) Provisional application No. 63/064,228, filed on Aug. 11, 2020.

(51) Int. Cl. G06Q 50/18; H04L 29/06; G06F 21/62

(52) U.S. Cl. CPC G06Q 50/18; G06F 21/6227; H04L 63/04

(57) ABSTRACT

A system and method for attorney-client privileged digital evidence capture, analysis and collaboration is presented herein. In particular, the system and method facilitates the capturing and analysis of evidentiary digital images, audio, video or audiovisual files (“Evidence”) via smart phones, cameras, digital recording devices, personal computers, connected Internet of Things (IoT) devices and other networked machines capable of capturing digital images, audio, video or audiovisual recordings and data by verified people, devices and machines. The system and method further facilitates secure, attorney-client privileged information, storage, communication and collaboration with respect to such evidence, and allows access and collaboration by authorized third parties with permission.

### CLAIM OF PRIORITY/CROSS-REFERENCE TO RELATED APPLICATION

The present application is based on and a claim of priority is made under 35 U.S.C. § 119(e) to provisional patent application Ser. No. 63/064,228, filed on Aug. 11, 2020, the contents of which are incorporated herein in their entirety by reference.

### FIELD OF THE INVENTION

The present invention is generally directed to a system, software, method and/or process, and more specifically to a system and method for attorney-client privileged digital evidence capture, analysis and collaboration.

### BACKGROUND OF THE INVENTION

As a result of mobile devices with native video and audio capturing capabilities (e.g., smart phones and tablet computers) being ubiquitous in today's society, the capturing of media (e.g., in the form of videos, audio, and photographs) of public, and in some cases private, altercations, conflicts, or events, has grown substantially over the last several years. More specifically, various events such as physical or verbal altercations, arrests by police offices and other public officials, are often captured by witnesses of and/or participants to the event. Unfortunately, however, once the media of the event is captured, in many cases, the witness, participant or person who captured the media is often unsure what to do with the media or want can or should be done with the media. In many cases, the media captured may be valuable evidentiary material that can or should be associated with a legal matter.

Accordingly, there is a need in the art for a system and/or method that provides an easy, streamlined way for a user to submit the media to an attorney or a group of attorneys for legal review and analysis. It would be beneficial if the submission (e.g., the media captured by the user and submitted to the attorney or group of attorneys) can be protected by an attorney-client privilege and remain confidential. It would also be beneficial if the user is able to collaborate with the attorney or group of attorneys in the form of secure privileged communications regarding the media submission and the associated legal matter.

U.S. Pat. No. 8,255,800 entitled “Systems and Methods for Facilitating Attorney-Client Relationships, Document Assembly and Nonjudicial Dispute Resolution,” was issued to Rocket Lawyer Incorporated on Aug. 28, 2012. The contents of U.S. Pat. No. 8,255,800 are incorporated herein in their entirety by reference. Certain embodiments of the present invention as disclosed herein are directed to novel improvements or modifications in the form of systems and methods for attorney-client privileged digital evidence capture, analysis and collaboration.

### SUMMARY OF THE INVENTION

The system and method of at least one embodiment facilitates capture and analysis of evidentiary digital images, audio, video or audiovisual files (“Evidence”) via smart phones, cameras, digital recording devices, personal computers, connected Internet of Things (IoT) devices and other networked machines capable of capturing digital images, audio, video or audiovisual recordings and data by verified people, devices and machines. The system and method further facilitates secure, attorney-client privileged information, storage, communication and collaboration with respect to such evidence, and allows access and collaboration by authorized third parties with permission.

In particular, the system and/or method of at least one embodiment, as disclosed herein includes an application or “app” to capture digital images, audio, video or audiovisual evidence, and to facilitate communication and collaboration between a person and his/her attorney, and permitted third parties. In some embodiments, Internet of Things (IoT) devices and/or other networked machines may also be used to capture digital recordings, files and data for use as the or as part of the evidence submission.

A Digital Evidence Mediator is also included which mediates secure evidence storage, and communication and collaboration between a person or user, his/her attorney or legal representative, and permitted third parties, and system event logging. Further embodiments also include one or more proprietary Artificial Intelligence (“AI”) computer programs that automatically analyze digital evidence to extract, evaluate and generate data from machine learning and machine reasoning to categorize and support due process and advocacy with respect to the submission or digital evidence. A tamper-proof database or third party tamper-proof blockchain may also be included or implemented which logs, e.g., permanently or long term, all system events securely and in a tamper-proof format. Further, cloud or remotely located storage devices or systems may also be included that securely store digital evidence and machine generated data.

More specifically, the system and method of at least one embodiment of the present invention operates in the following manner:

### Verified Evidence Capture:

A person (e.g., a user or client) logs into his or her user account in a mobile or other application installed on a personal, natively digital device, such as a phone or tablet. In some cases, the user or client may log into the application using biometric or other secure authentication, such as fingerprint, face or voice recognition to ensure or further validate that the user's identity is verified before accessing and using the application.

Next, the user or client uses the application to securely capture digital video, audio, images, or other digital files as evidence in a tamper-proof format in the application. The digital evidence files can be created by the natively digital device directly or they can be imported from other digital devices, including Internet of Things (IoT) devices and other networked machines, such as smart home devices, smart healthcare devices, and transportation systems.

Optionally, the user or client can then use the application to write or record a message in a written, audio or video format, and choose whether to create a new legal matter or attach their message and digital evidence files to an existing legal matter.

### Established Privilege:

Using the application, the user or client submits their captured evidence files and in some cases message along with their account, verified identity, personal details, and other automatically captured evidence data, including the date, time, location, file format, device type and ID used to capture the evidence.

Upon submission, if it is a new legal matter then the user or client reviews and consents to a digital limited (aka “unbundled”) Legal Services Agreement for advice on the legal matter with an assigned attorney. If it is an existing legal matter then upon submission the user or client is informed that the evidence is to be included in their existing legal matter. Either way, this ensures that the evidence files and data and message is subject to attorney-client privilege.

### Secure Transmission and Storage:

The submission (e.g., digital evidence and message) is securely transmitted to and processed by a third party service (e.g., an evidence mediator or management system) that securely stores the content, for example, in the cloud, in a tamper-proof format. In some embodiments, the original evidence and message on the device is compared with the evidence and message stored in the cloud to ensure that it has not been altered during transmission from the device to the cloud.

A permanent record of the submission, including the evidence and message, is securely logged, for example, in the user's account in association with the legal matter in a tamper-proof database, in a third-party tamper-proof blockchain, or in another location.

### Evidence Analysis:

Once the submission, e.g., the digital evidence, is stored securely in the cloud then the evidence is automatically subjected to algorithmic analysis by one or more proprietary Artificial Intelligence (AI) computer programs to extract and generate useful data from machine learning and machine reasoning in order to analyze, categorize, evaluate and assist due process and attorney advocacy with respect to the evidence, and to enable the evidence mediator or management system to manage security and other risks associated with the evidence.

The AI generated data is stored securely, for example, in the cloud, with the submitted evidence in a tamper-proof format.

Next the assigned attorney is notified about the evidence submission to the legal matter via the evidence mediator.

The attorney or legal representative logs into the application on his or her device or computer. In some cases, the attorney or legal representative may need to use biometric or other two factor authentication method in order to verify his or her identity and log in.

Next, the attorney or legal representative accesses and reviews the untampered submission, e.g., the evidence, the message, authenticated identity of the user or client, and AI generated data associated with legal matter, that is stored securely in the cloud.

A permanent record of this attorney review of the evidence and AI generated data by the attorney is logged securely in the person's and attorney's accounts in association with the legal matter in the tamper-proof database, a third party tamper-proof blockchain or other location.

### Secure Communication & Collaboration:

Using the application on their devices the attorney and the user or client are able to communicate securely via the evidence mediator about the legal matter, including the digital evidence and AI generated data, by all forms of digital communication, including real-time and asynchronous text messages, audio and video communications.

Using the application on their devices the attorney and user or client are also able to collaborate by securely uploading, sharing, and creating digital files, including documents, images, graphics and illustrations, in relation to the legal matter. via the evidence mediator.

All digital communications and all digital files shared and created between the attorney and user or client are stored securely in the cloud in a tamper-proof format.

The user or client and attorney, with the user's permission, are able to invite third parties via the evidence mediator, including witnesses to the digital evidence capture and other attorneys, to view and comment on all or parts of the files and data in the legal matter. The third parties, with permission, are also able to communicate, upload and create files in collaboration with the user or client and attorney via the evidence mediator.

A permanent record of all file access, communications, and file collaborations by the person, attorney and invited third parties is logged securely in the person's and attorney's accounts in association with the legal matter in a tamper-proof database or in a third party tamper-proof blockchain.

These and other objects, features and advantages of the present invention will become more apparent when the drawings as well as the detailed description are taken into consideration.

### BRIEF DESCRIPTION OF THE DRAWINGS

FIG. 1 is a block diagram of the system for attorney-client privileged digital evidence capture, analysis and collaboration as disclosed in accordance with at least one embodiment of the present invention.

FIG. 2A is an exemplary block diagram of the user or client device which can be operated to capture evidence, among other features, as disclosed in accordance with at least one embodiment of the present invention.

FIG. 2B is an exemplary block diagram of the attorney or legal representative device which can be operated to access and review evidence, among other features, as disclosed in accordance with at least one embodiment of the present invention.

FIG. 2C is an exemplary block diagram of the evidence mediator and/or management system as disclosed in accordance with at least one embodiment of the present invention.

FIG. 3 is a schematic flow diagram of the system and method for attorney-client privileged digital evidence capture, analysis and collaboration as disclosed in accordance with at least one embodiment of the present invention.

FIGS. 4A, 4B and 4C collectively illustrate a high level flow chart of the method for attorney-client privileged digital evidence capture, analysis and collaboration as disclosed in accordance with at least one embodiment of the present invention.

Like reference numerals refer to like parts throughout the several views of the drawings provided herein.

### DETAILED DESCRIPTION OF THE INVENTION

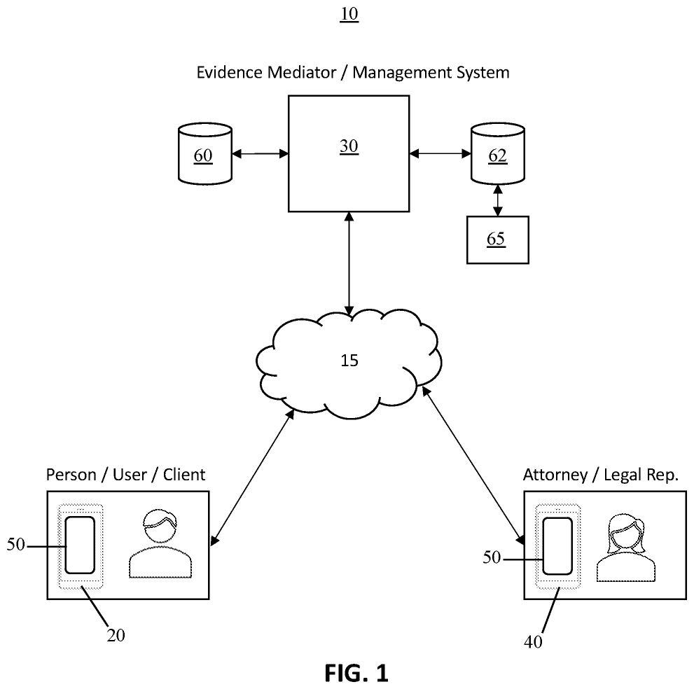

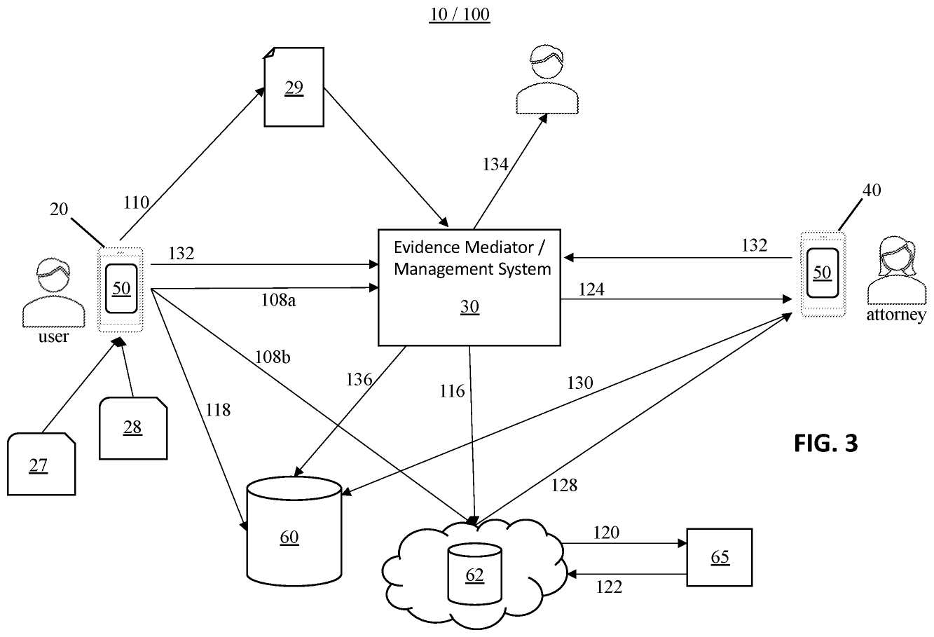

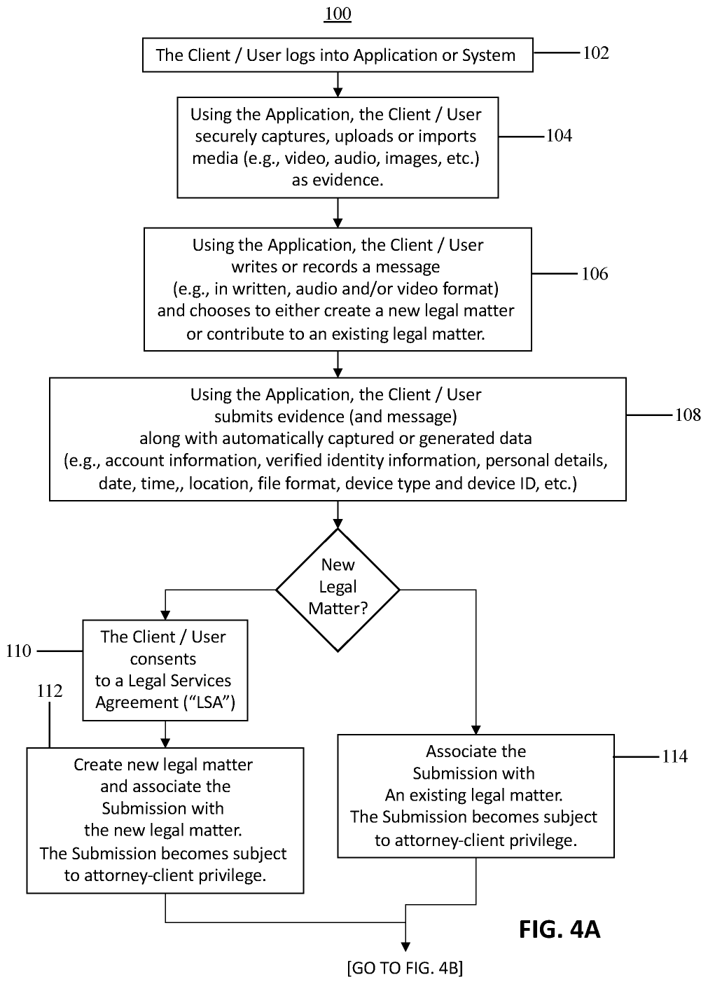

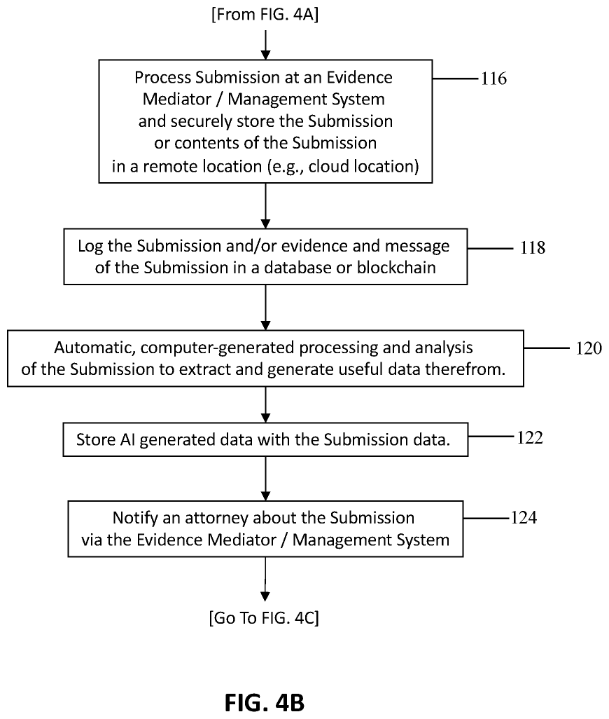

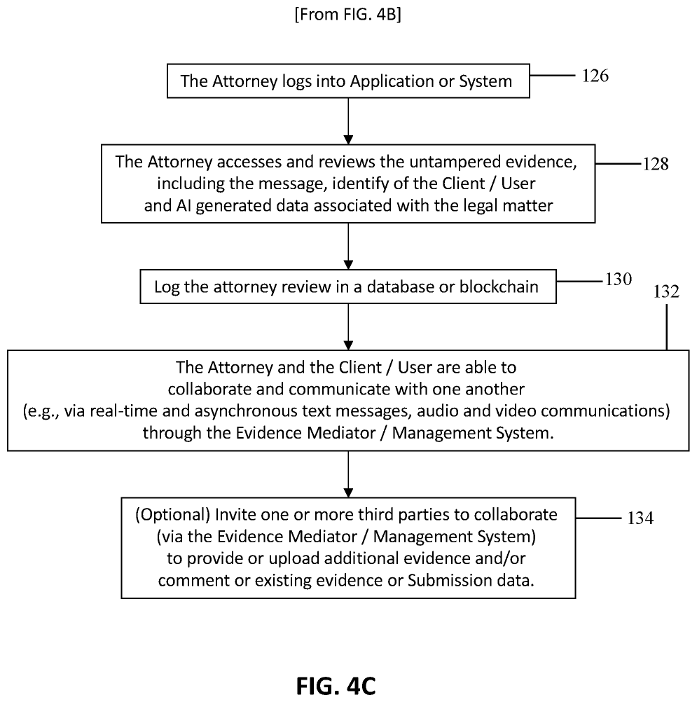

As shown in the accompanying drawings, and with particular reference to FIGS. 1 and 3, at least one embodiment of the present invention is directed to a system, generally referenced as 10, that facilitates the capture and analysis of evidentiary media, such as, digital images, audio, video or audiovisual files, captured or submitted by a user device, such as, a smart phone, camera, digital recording device, personal computer, connected Internet of Things (IoT) device and/or other networked machines capable of capturing digital images, audio, video or audiovisual recordings and data by verified people, devices and machines. In other embodiments, for example, as referenced in FIGS. 3 and 4A-4C, the present invention is directed to a method, generally referenced as 100, that facilitates the capture and analysis of evidentiary media, as described herein.

Furthermore, the system 10 and method 100 of certain embodiments of the present invention disclosed herein further facilitates secure, attorney-client privileged information, storage, communication and collaboration with respect to such evidence, and allows access and collaboration by authorized third parties with permission. In other words, when a user or client uploads or otherwise transmits media or other evidence submission via the system 10 and/or method 100 of the present invention, that media, submission or evidence is protected by or otherwise covered by an attorney-client privilege, as governed or defined by one or more applicable state bar associations, statutes, laws, policies and/or the Model Rules of Professional Conduct.

Moreover, with reference to FIG. 1, the system 10 of at least one embodiment includes, among other structures and features, a user device 20, an evidence mediator or management system 30 and an attorney or legal representative device 40. As described herein, an application 50, such as but not limited to a mobile application, desktop application, computer-based application, tablet application, web-based or web-accessible application, website, etc. may be accessible on or by the user device 20 and/or the attorney device 40 in order to implement or facilitate the implementation of certain features and functions of the present invention.

Furthermore, and still referring to the schematic or block diagram of FIG. 1, the system 10 of at least one embodiment includes or otherwise operates via communication through one or more networks or communication channels generally referenced as 15. For instance, the various devices such as the user device 10, attorney device 40, application 50, evidence mediator or management system 30, etc. communicate over or through one or more networks 15. Multiple modes or channels of communication may be implemented such that the devices 20, 30, 40 can communicate over various networks 15 such as data networks, communication networks, telecommunication networks or virtually any network within the full spirit and scope of the present invention.

Accordingly, the network(s) or communication channel(s) 15 may be defined as or otherwise include the World Wide Web or Internet, telecommunication networks such as 3G, 4G, 5G, LTE, etc., Intranet, Wide Area Networks, global telex networks, data or TCP/IP networks, such as Wide Area Networks (WAN), Metropolitan Area Networks (MAN), Local Area Networks (LAN), Internet Area Networks (IAN), Bluetooth, Near-field Communication (NFC) networks, etc., or any combination thereof. Particularly, the network(s) 15 can include any known networks for facilitating communicate of media such as audio, video and/or data communications such as, for example, a cellular network, local area network (LAN), the internet, VOIP, or SMS service, etc.

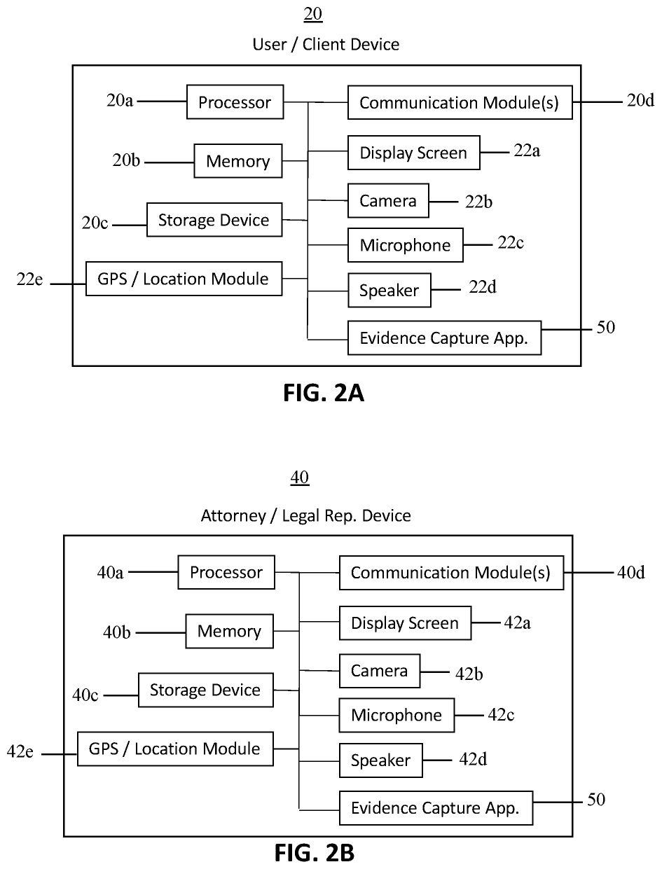

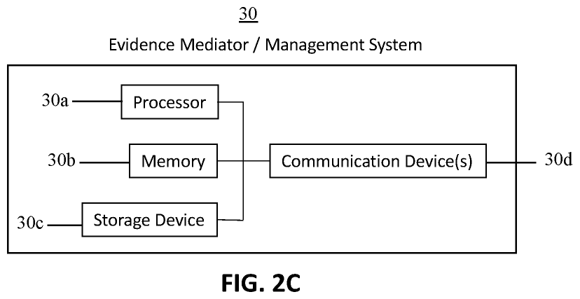

With reference to FIG. 2A, the user or client device 20 of at least one embodiment may include, among other components and devices structured to facilitate implementation of the present invention in the intended manner, a processor 20a, memory 20b, a data storage device 20c, a and one or more communication modules 24d.

Specifically, as used herein, the processor 20a of at least one embodiment may include any device cooperatively structured to execute or implement computer instructions, software, etc., including, for example, the various features and components as described in accordance with at least one embodiment of the present invention, such as one or more applications or operating systems executing on the device 20. The memory device 20b, as used herein, may include but is not limited to random access memory (RAM) or other like devices configured to implement the present invention in the intended manner, for example, by storing and assisting with the execution of one or more applications, modules, or components capable of implementing the system 10, method 100, and features thereof as described herein. In some cases, the processor 20a and memory 20b can be combined to a single microcontroller as is known in the art. Further, the data storage device 20c, as used herein, may include a hard disk drive, solid state drive, virtual drive, could-based storage drive, or other types of volatile or non-volatile memory. It should be noted that non-transitory computer readable media includes all computer-readable media except for a transitory, propagating signal. The one or more communication modules 20d, as used herein, includes one or more modules implemented in hardware and/or software adapted to communicate a signal, message, or data communication via the network(s) 15, for example, to/from the evidence mediator/management device 30 or attorney device 40.

In addition, the user device 20 of at least one embodiment may include other modules, features or structures implemented in hardware and/or software which facilitate implementation of various features described herein, such as, but not limited to a display screen 22a, a camera 22b (e.g., capable of recording or obtaining still and moving images or video as described herein), a microphone 22c, one or more speakers 22d, a location detection device or module (e.g., GPS) 22e, etc. Some embodiments may include a gyroscope and/or accelerometer, for example, to track movement of the device.

Accordingly, the user device 20 of certain embodiments or implementations of the present invention may include any mobile device or mobile terminal such as, but not limited to a mobile phone, smartphone, tablet computer, etc. (e.g., APPLE® iPHONE®, ANDROID® based phone, etc.). In other cases, the user or client device 20 may be virtually any computer device or system such as any laptop or mobile computers, desktop computers, etc.

With reference to now to the schematic of FIG. 2B, the attorney or legal representative device 40 may include, among other components and devices structured to facilitate implementation of the present invention in the intended manner, a processor 40a, memory 40b, a data storage device 40c, and one or more communication modules 40d.

Specifically, as used herein, the processor 40a of at least one embodiment may include any device cooperatively structured to execute or implement computer instructions, software, etc., including, for example, the various features and components as described in accordance with at least one embodiment of the present invention, such as the application 50. The memory device 40b, as used herein, may include but is not limited to random access memory (RAM) or other like devices configured to implement the present invention in the intended manner, for example, by storing and assisting with the execution of one or more applications, modules, or components capable of implementing the system 10, method 100 and features thereof as described herein. In some cases, the processor 40a and memory 40b can be combined to a single microcontroller as is known in the art. Further, the data storage device 40c, as used herein, may include a hard disk drive, solid state drive, virtual drive, could-based storage drive, or other types of volatile or non-volatile memory. It should be noted that non-transitory computer readable media includes all computer-readable media except for a transitory, propagating signal. The one or more communication modules 40d, as used herein, includes one or more modules implemented in hardware and/or software adapted to communicate a signal, message, or data communication via the network(s) 15, for example, to/from the evidence mediator/management device 30 or user/client device 20.

In addition, the attorney or legal representative device 40 of at least one embodiment may include other modules, features or structures implemented in hardware and/or software which facilitate implementation of various features described herein, such as, but not limited to a display screen 42a, a camera 42b, a microphone 42c, one or more speakers 42d, a location detection device or module (e.g., GPS) 42e, etc. Some embodiments may include a gyroscope and/or accelerometer, for example, to track movement of the device.

Accordingly, the attorney device 40 of certain embodiments or implementations of the present invention may include any mobile device or mobile terminal such as, but not limited to a mobile phone, smartphone, tablet computer, etc. (e.g., APPLE® iPHONE®, ANDROID® based phone, etc.). In other cases, the user or client device 20 may be virtually any computer device or system such as any laptop or mobile computers, desktop computers, etc.

With reference to now to the schematic of FIG. 2C, the evidence mediator or management system 30 of at least one embodiment may include, among other components and devices structured to facilitate implementation of the present invention in the intended manner, a processor 30a, memory 30b, a data storage device 30c, and one or more communication modules 30d.

Specifically, as used herein, the processor 30a of at least one embodiment may include any device cooperatively structured to execute or implement computer instructions, software, etc., including, for example, the various features and components as described in accordance with at least one embodiment of the present invention. The memory device 30b, as used herein, may include but is not limited to random access memory (RAM) or other like devices configured to implement the present invention in the intended manner, for example, by storing and assisting with the execution of one or more applications, modules, or components capable of implementing the system 10, method 100 and features thereof as described herein. In some cases, the processor 30a and memory 30b can be combined to a single microcontroller as is known in the art. Further, the data storage device 30c, as used herein, may include a hard disk drive, solid state drive, virtual drive, could-based storage drive, or other types of volatile or non-volatile memory. It should be noted that non-transitory computer readable media includes all computer-readable media except for a transitory, propagating signal. The one or more communication modules 30d, as used herein, includes one or more modules implemented in hardware and/or software adapted to communicate a signal, message, or data communication via the network(s) 15, for example, to/from the user or client device(s) 20 or attorney device(s) 40.

Accordingly, the evidence mediator or management system 30 of at least one embodiment may include one or more servers that provides functionality to other devices or clients, or other computer systems or device, such as one or more desktop computers, laptop computers, mobile computers or devices, etc. capable of facilitating operation of the various embodiments in the intended manner.

Referring again to FIG. 1, the system 10 of at least one embodiment of the present invention may also include additional structures and items, including, for example, a database or blockchain, referenced as 60, which can operate to securely store, track and log operations of the present invention. For instance, as will be described herein, the database or blockchain 60 can securely and in some cases remotely store a list of activities performed by the user (or user device), the attorney (or attorney device 40) and/or the evidence mediator 30 in connection with the present invention. In this manner, all activities or operations will be logged and stored in the event they need to be recalled or accessed at a later time, for example, during subsequent litigation, trial or pre-trial events.

In addition, the system 10 of at least one embodiment may also include one or more storage devices or locations, generally referenced as 62, where, as described herein, various data, evidence, communications, etc. generated in connection with the various embodiments of the present invention can be stored. The storage device or location 62 may, in some cases, be remotely located relative to the evidence mediator or management system 30, such that, the storage device or location 62 may, in some cases, be considered a cloud storage device or location. In other embodiments, the storage device or location 62 may be local to the evidence mediator or management system 30. In either case, the storage device(s) 62 of at least one embodiment of the present invention can operate to securely store the submission (e.g., media or other evidence) provided by the user (e.g., via the user device 20), machine generated data (e.g., as a result of automatic or machine analysis of the submission), as well as collaboration data, files, and communications between the attorney and client or user.

Furthermore, as also shown in the exemplary schematic of FIG. 1, the system 10 may include one or more programs or applications, generally referenced as 65, which operate to analyze the user's submission (e.g., media and other evidence) and create or generate machine generated data that can be used to assist the attorney during his or her evaluation of the submission or evidence. In this manner, the programs or applications 65 may be in communication with the storage device 62 in order to access the data or evidence, and to perform automatic machine analysis thereupon. The machine generated data, once created by the programs or applications 65, can then be stored in the data storage device 62, and associated with the original evidence submission data. In this manner, when the attorney or legal representative performs his or her analysis on the evidence submission, the machine generated data can also be of assistance during that analysis.

Referring now to FIGS. 3 and 4A-4C, the method 100 of at least one embodiment of the present invention is shown. In particular, as shown at 102, the method 100 of at least one embodiment begins when a person (e.g., a user or client) logs into his or her user account. This may be accomplished in some cases by accessing mobile or other application 50 installed on a personal digital device 20, such as, but not limited to, a phone or tablet. In some cases, the user or client may log into the application 50 using biometric or other secure authentication, such as fingerprint, face or voice recognition to ensure or further validate that the user's identity is verified before accessing and using the application 50. It should also be noted that in some embodiments, the application 50 may be accessible via other user devices such as a computer, e.g., via an application installed on the device and/or accessing a web page via a web browser. Other ways of accessing the application, system or method are contemplated within the full spirit and scope of the present invention.

Next, as shown at 103, the user or client uses the application 50 to securely capture media or other content, including, but in no way limited to digital video, audio, images, or other digital files as evidence in a tamper-proof format in the application 50. The media or digital evidence files can be created by the user or client device 20 directly or they can be imported from other digital devices, including Internet of Things (IoT) devices 27 and other networked machines 28, such as smart home devices, smart healthcare devices, and transportation systems. In other words, the media or evidence file(s), as used herein, can in some cases be captured by the camera, microphone, or other features of the user device 20, itself. In other cases, the media or evidence file(s) may be imported or captured by other device(s) such as other computing devices, phones, cameras, IoT devices, etc.

Optionally, as shown at 106, the user or client can then use the application 50 to write or record a message, for example, in a written, audio or video format, and choose whether to create a new legal matter or attach their message and digital evidence files to an existing legal matter.

Next, as shown at 108, in at least one embodiment of the method 100, using the application 50, the user or client submits or transmits the media, e.g., the captured evidence files and in some cases message to the evidence mediator 30 (108a) and/or to the cloud or other storage 62 (108b). The media and message are referenced herein in some cases as the submission or the evidence. It should also be noted that in some embodiments, the submission or evidence may also include additional information and data corresponding to the user, the user device, and/or the evidence captures, such as, but in no way limited to the user's account identification or information (e.g., username, unique account ID, etc.), verified identity information or data (e.g., biometric data, multi-factor authentication or MFA data, or information or data indicating whether the user's credential or identity are verified using biometric, MFA or other authentication protocols), personal details (e.g., name, phone number, email, address, etc.), and other automatically captured evidence data or meta data corresponding to the user device or media, including the date, time, location, file format, device type and ID used to capture the evidence.

Upon submission, if it is a new legal matter, then, as shown at 110, the user or client reviews and consents to a digital limited (aka “unbundled”) Legal Services Agreement or LSA, generally referenced as 29 in FIG. 2, for advice on the legal matter with an assigned attorney. As shown at 112, a new legal matter is then created, and the submission or evidence is then associated with the new legal matter, for example, via a unique matter ID or other like manner. When the submission or evidence is transmitted, e.g., to the evidence mediator 30 and/or the remote or cloud storage 62, the submission or evidence becomes subject to and protected by an attorney-client privilege, for example, but not limited to as governed or defined by one or more applicable state bar associations, statutes, laws, policies and/or the Model Rules of Professional Conduct.

If, on the other hand, there is already an existing legal matter for which the user would like to add the submission to, then, as shown at 114, upon transmission or communication of the submission or evidence, the user or client is informed that the evidence is to be included in their existing legal matter. Again, when the submission or evidence is transmitted, e.g., to the evidence mediator 30 and/or the remote or cloud storage 62, the submission or evidence becomes subject to and protected by an attorney-client privilege, for example, but not limited to as governed or defined by one or more applicable state bar associations, statutes, laws, policies and/or the Model Rules of Professional Conduct.

Furthermore, the method 100 of at least one embodiment includes receiving and processing the submission (e.g., digital evidence and message) by the evidence mediator or management system 30. In particular, the evidence mediator 30, upon receipt of the media and/or evidence submission, process the submission by extracting certain data, formatting or reformatting the media or submission, associating the submission with the user account, etc. The evidence mediator or management system 30 may then securely store the content or submission, for example, in the cloud or remote storage device 62 or locally in a local storage device (local to the evidence mediator 30, not shown) and in a tamper-proof format. In some embodiments, the original evidence and message on the device 20 is compared with the evidence and message stored in the cloud 62 or other storage device to ensure that the submission, media or evidence has not been altered, contaminated or corrupted during transmission from the device 20 to the storage 62.

With reference now to 118 in FIGS. 3 and 4B, in at least one embodiment a permanent or long term record of the submission, including the evidence and message, is securely logged, for example, in the user's account (or in association with the user's account) and in association with the legal matter. In some embodiments, the log or record is stored in a tamper-proof database, in a third-party tamper-proof blockchain, or in another location, as generally referenced as 60 in FIG. 3.

As shown at 120 in FIGS. 3 and 4B, in at least one embodiment of the present invention, once the submission, e.g., the digital evidence and/or message, is stored securely in the storage device 62, the evidence may be automatically subjected to algorithmic or other analysis by one or more programs or applications, such as, for example, one or more proprietary Artificial Intelligence (AI) computer programs. The AI or other program(s) which analyze the submission or evidence are adapted and configured to extract and generate useful data from machine learning and machine reasoning in order to analyze, categorize, evaluate and assist due process and attorney advocacy with respect to the evidence, and to enable the evidence mediator or management system to manage security and other risks associated with the evidence. Then at 122, the generated data from the algorithmic or other analysis is stored securely, for example, in the cloud or other storage device 62, with the submitted evidence in a tamper-proof format.

In particular, the one or more AI or other programs or applications at 120 may analyze the media for various types of information related to the media which may be helpful to the attorney during his or her review or legal analysis thereof. As just an example, the program(s) or application(s) may be configured or adapted to identify the type of conflict depicted or captured in the media. For instance, whether the conflict includes a physical altercation, verbal altercation, the number of participants involved in the altercation or conflict, whether the conflict or altercation is racially motivated or motivated by other factors, etc. In this manner, the program(s) or application(s) may generate notes, tags, or other indicators to represent these and other aspects that were or are identified in the media. In some cases, during the analysis at 120, the program(s) or application(s) may: create or generate an audio transcript of the media; use facial recognition to identify, attempt to identify or distinguish between various participants or individuals appearing in the media; identify whether the media has any indicators of being modified during or after being recorded or captured; identify whether the media is related to another matter (e.g., a different view or angle from an already-created matter), etc.

Next, in at least one embodiment of the method 100 of the present invention, as shown at 124, the assigned attorney or legal representative is notified (e.g., by email, text message, push notification, in-application message, etc.) about the evidence submission to the legal matter via the evidence mediator 30.

With reference now to FIG. 4C, and in particular as shown at 126, the attorney or legal representative may then log into the application 50, for example, on his or her device or computer 40. In some cases, the attorney or legal representative may need to use biometric, two-factor or multi-factor authentication MFA, or other authentication or verification method(s) in order to verify his or her identity and log in to the application 50 to access the system 10 or method 100 of the present invention.

Next, as shown at 128, using the application 50, the attorney or legal representative accesses and reviews the submission, e.g., the evidence or media, the message created by the user or client, authenticated identity information or data of the user or client, and the automated data generated at 120 and associated with legal matter, that is stored securely in the storage device(s) 62.

As shown at 130 in FIGS. 3 and 4C, a permanent, long term or other record of this attorney review of the evidence and automatically generated analysis data by the attorney is logged or otherwise stored securely in the user's account, the attorney's account and in association with the legal matter, for example, in the database, a blockchain or other location 60.

Furthermore, in at least one embodiment, using the application 50 on their respective devices 20, 40 the attorney and the user or client are able to communicate securely with one another for example, through the evidence mediator 30 or directly bypassing the evidence mediator 30. The content of the communications may be about the legal matter, including the digital evidence or submission, the message, and generated analysis data, and may be via any one or more forms of digital or other communication, including real-time and asynchronous text messages, audio and video communications, etc.

Additionally, in at least one embodiment, using the application 50 on their respective devices 20, 40 the attorney and user or client are also able to collaborate with one another by securely uploading, sharing, and creating digital files, including documents, images, graphics and illustrations, in relation to the legal matter via the evidence mediator 30.

All digital communications and all digital files shared and created between the attorney and user or client are stored securely in the cloud in a tamper-proof format. In addition, all digital communication and all digital files shared and created between the attorney and the user via the system 10 and/or method 100 of the present invention may be or are protected by or otherwise covered by an attorney-client privilege, as governed or defined by one or more applicable state bar associations, statutes, laws, policies and/or the Model Rules of Professional Conduct.

Furthermore, in at least one embodiment of the present invention, as referenced at 134, the user or client and attorney, with the user's permission, are able to invite one or more third parties via the evidence mediator 30, including, as an example, one or more witnesses to the digital evidence capture and other attorneys, to view and comment on all or parts of the files and data in the legal matter. The third parties, with permission, are also able to communicate, upload and create files in collaboration with the user or client and attorney via the evidence mediator 30.

As shown at 136, a permanent record of all file access, communications, and file collaborations by the person, attorney and invited third parties is logged securely in the person's and attorney's accounts in association with the legal matter in a database, in a blockchain or other secure location.

Since other modifications and changes varied to fit particular operating requirements and environments will be apparent to those skilled in the art, the invention is not considered limited to the example chosen for purposes of disclosure, and covers all changes and modifications which do not constitute departures from the true spirit and scope of this invention. This written description provides an illustrative explanation and/or account of the present invention. It may be possible to deliver equivalent benefits using variations of the specific embodiments, without departing from the inventive concept. This description and these drawings, therefore, are to be regarded as illustrative and not restrictive.

Now that the invention has been described,

What is claimed is:

1. A method for attorney-client privileged digital evidence capture, analysis and collaboration, the method comprising:
using at least a first processor of a user device:
generating an evidence submission via a mobile application executing on the user device, the evidence submission comprising at least one digital media file,
transmitting the evidence submission to an Evidence Mediator via at least one communication network,
using at least one second processor at the Evidence Mediator:
receiving the evidence submission and storing the evidence submission in a secure database,
associating the evidence submission with a legal matter, and
establishing evidence submission as being subject to an attorney-client privilege, and
communicating a notification to an attorney device that the evidence submission was submitted and is ready for attorney evaluation,
using at least one third processor on the attorney device:
accessing and reviewing the evidence submission, and
initiating collaborative communication with the user device.

2. The method as recited in claim 1 wherein the at least one digital media file of the evidence submission is generated by the user device.

3. The method as recited in claim 1 wherein the at least one digital media file of the evidence submission is generated by an external device and uploaded to the user device.

4. The method as recited in claim 1 further comprising defining the evidence submission generated by the first processor as comprising a digital message provided by the user.

5. The method as recited in claim 1 further comprising, using the at least one second processor, processing the evidence submission using algorithmic artificial analysis to extract and generate AI evaluation information corresponding to the evidence submission.

6. The method as recited in claim 5 further comprising storing the AI evaluation information in association with the evidence submission.

7. A system for attorney-client privileged digital evidence capture, analysis and collaboration, the system comprising:
a user device, the user device comprising a camera, a processor, and a memory in communication with the processor, the processor being configured to execute computer instructions stored on the memory to perform the steps of:
generating an evidence submission via a mobile application executing on the user device, the evidence submission comprising at least one digital media file, and
transmitting the evidence submission to an Evidence Mediator via at least one communication network,
an evidence mediator, the evidence mediator comprising a processor, and a memory in communication with the processor, the processor being configured to execute computer instructions stored on the memory to perform the steps of:
receiving the evidence submission from the user device and storing the evidence submission in a secure storage device,
associating the evidence submission with a legal matter, and
establishing the evidence submission as being subject to an attorney-client privilege, and
communicating a notification to an attorney device that the evidence submission was submitted and is ready for attorney evaluation,
an attorney device, the attorney device comprising a processor, and a memory in communication with the processor, the processor being configured to execute computer instructions stored on the memory to perform the steps of:
accessing and reviewing the evidence submission, and
initiating collaborative communication with the user device.

8. The system as recited in claim 7 wherein said processor of said user device is further configured to securely capture at least one digital media file via a mobile application executing on the user device and associate the at least one digital media file with said evidence submission.

9. The system as recited in claim 8 wherein said processor of said user device is further configured to capture a digital message and to associate said digital message with the evidence submission.

10. The system as recited in claim 7 wherein said processor of said evidence mediator is further configured to process the evidence submission using algorithmic artificial analysis to extract and generate AI evaluation information corresponding to the evidence submission.

11. The system as recited in claim 19 wherein said processor of said evidence mediator is further configured to store the AI evaluation information in association with the evidence submission.
